(19) United States
(12) Patent Application Publication
(10) Pub. No.: US 2012/0324963 A1
(43) Pub. Date: Dec. 27, 2012

(54) Motor locking system to prevent unauthorized manual operation of automatic gates

(75) Inventors: Alex Parsadayan, Monarch Beach, CA (US); Wayne C. Hom, Coto De Caza, CA (US)

(73) Assignee: Maximum Controls, L.L.C.

(21) Appl. No.: 13/135,068

(22) Filed: Jun. 24, 2011

(51) Int. Cl. E05B 47/00; E05B 65/00

(52) U.S. Cl. 70/77

(57) ABSTRACT

A lock module housing containing the components of a preferred embodiment is physically mounted to the rear of a gate drive motor of an automatic gate system. A solenoid front shaft, when the solenoid is de-energized, is pushed into a sprocket attached to the drive motor, thus preventing the motor shaft from turning. To release the drive motor, the solenoid is energized. The solenoid rear shaft contacts a limit switch to indicate to the controller that the drive motor is indeed unlocked. When the controller is about to move the gate, energizing the solenoid retracts the shaft and allows normal operation of the gate control system. At the end of the gate cycle, the solenoid is de-energized and the drive motor is once again locked. In the case of a manual release, a key lock is turned from a first position to a second position to unlock the motor shaft. A mechanical linkage arm attached to the key lock pulls the solenoid shaft to its energized position, which in turn contacts the limit switch. The gate can then be back driven manually.

### BACKGROUND OF THE INVENTION

1. Field of the Invention

The present invention relates to the field of automatic barrier gates and specifically to a locking system for barrier gate motors to prevent unauthorized manual operation of the gate.

2. Background Discussion

The Underwriter's Laboratory has announced new safety requirements in its UL325 standard for vehicular gate systems. This new UL standard requires such gate systems to provide manual operation so that the gate can be moved independently of the operator. (30A.1.20) Meeting that requirement can make barrier gate systems vulnerable to unauthorized opening. Typical implementations either mechanically release the gate from the operator drive train or alter the drive train's gearing to allow the gate to be driven back manually from a closed position to an open position. The latter implementation compromises security because the gate can be manually forced open any time the gate is at rest. The solution to this problem is to provide a way of locking the gate operator motor to prevent unauthorized movement of the gate while still permitting simple authorized release, which can be accomplished either electrically or mechanically.

### SUMMARY OF THE INVENTION

A lock module housing containing the components of a preferred embodiment is physically mounted to the rear of the gate drive motor. A solenoid front shaft, when the solenoid is de-energized, is pushed into a sprocket attached to the drive motor, thus preventing the motor shaft from turning. To release the drive motor, the solenoid is energized. The solenoid rear shaft contacts a limit switch to indicate to the controller that the drive motor is indeed unlocked.

When the controller is about to move the gate, energizing the solenoid retracts the shaft and allows normal operation of the gate control system. At the end of the gate cycle, the solenoid is de-energized and the drive motor is once again locked.

In the case of a manual release, a key lock is turned from a first position to a second position to unlock the motor shaft. A mechanical linkage arm attached to the key lock pulls the solenoid rear shaft to its energized position, which in turn contacts the limit switch. The gate can now be back driven manually. As a safety feature, when the drive motor is mechanically released, the output of the limit switch prevents the gate controller from initiating any movement of the gate and thus preventing any injury to anyone pushing the gate.

As a convenience, an LED indicator is provided to visually indicate that the solenoid is in the energized position.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a preferred embodiment of the motor lock system of the present invention shown attached to the drive motor of a gate operator;

FIG. 2 is an enlarged three-dimensional view of the motor lock module of the preferred embodiment;

FIG. 3 is a further enlarged elevational view of the motor lock module;

FIG. 4 is a right side view of the preferred embodiment;

FIG. 5 is an elevational view thereof;

FIG. 6 is a left side view;

FIG. 7 is a top view;

FIG. 8 is a bottom view; and

FIG. 9 is a rear view of the preferred embodiment.

### DETAILED DESCRIPTION OF A PREFERRED EMBODIMENT

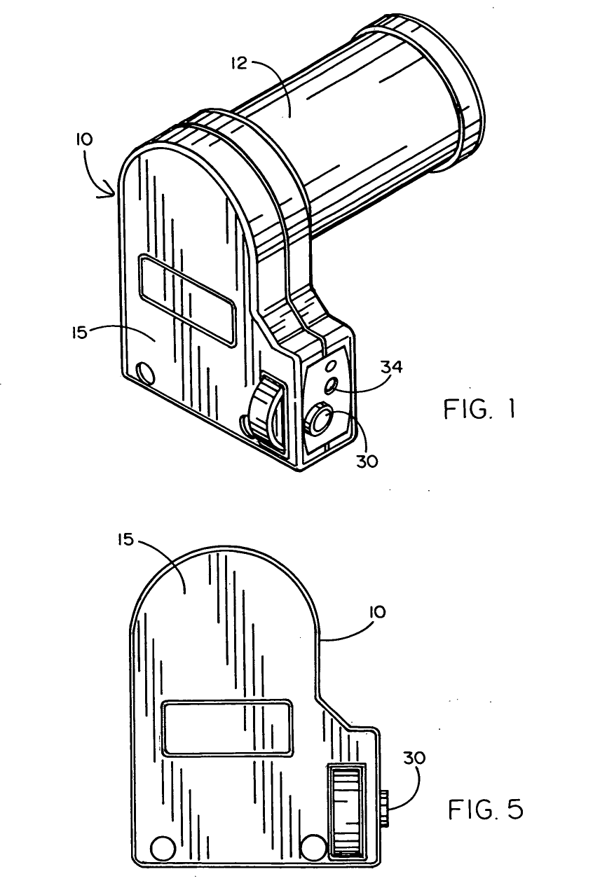

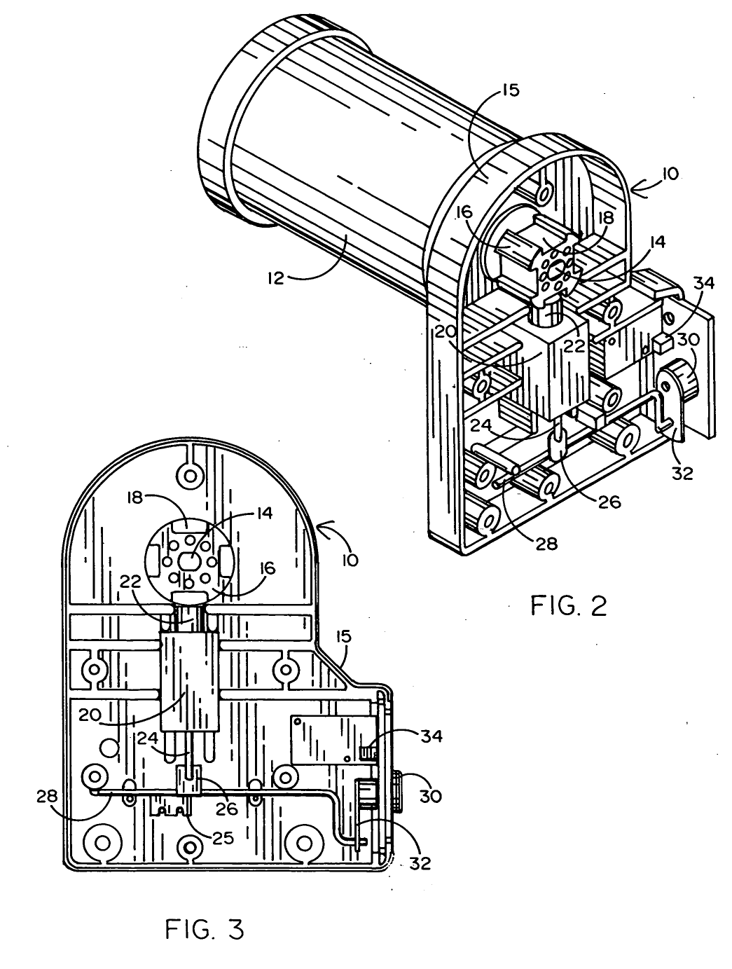

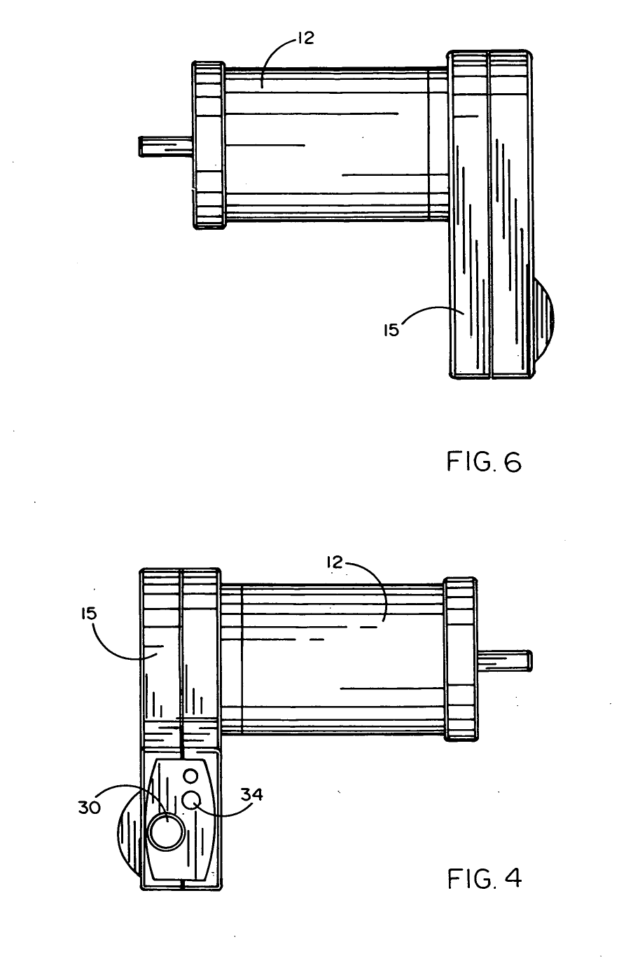

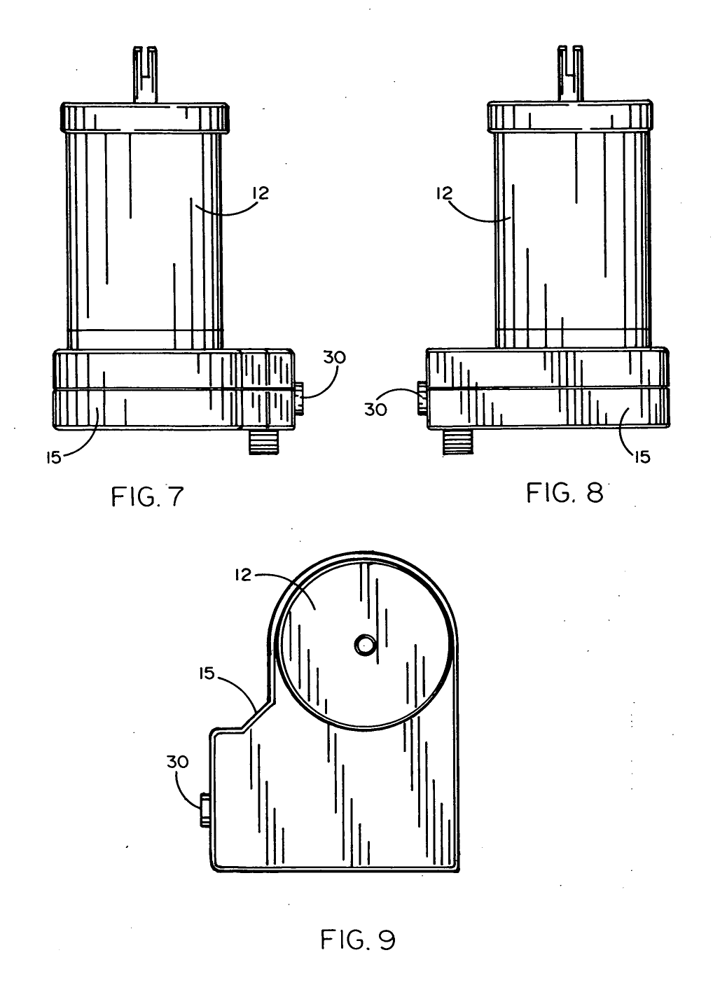

Referring to the accompanying drawings, namely FIGS. 1-9, it will be seen that a preferred embodiment of the present invention comprises a motor lock module 10 affixed to a rear extending drive motor shaft 14 of a drive motor 12. It will be understood that motor 12 drives the barrier or gate of any of several automatic gate systems that are well known in the art. Such systems are of the vehicle access types which, by way of example, may include sliding gates, swing gates, elevational arm gates and the like. Motor 12 has a front extending shaft 13 which normally engages the moveable member of such a gate for opening and closing thereof in response to a coded signal generated by a transmitter, keyboard operator or bar code reader and the like for permitting entry or exit of a vehicle into or out of a protected property.

The rear extending shaft 14 of drive motor 12 is mechanically engaged by a sprocket 16 which has a plurality of symmetrically positioned recesses 18. The drive motor 12 is of the type which when de-energized, automatically aligns a selected such recess 18 with a selected directional orientation, such a true vertical, in order to make the selected recess accessible to a main shaft 22 of a double-shafted solenoid 20. A second or rear shaft 24 of solenoid 20 has a linkage 26 which moves with the rear shaft depending upon whether the solenoid 20 is energized or de-energized. Solenoid shafts 22 and 24 move in tandem in the same direction. Linkage 26 is positioned to engage a limit switch 25, as well as a mechanical linkage arm 28. Arm 28 is connected mechanically to a key lock 30 through an arm actuator 32. An LED indicator 34 is preferable provided with an LED light which is visible externally through the lock module housing 15 on the right side of the motor lock module 10.

The lock module housing 15 is physically mounted to the rear of the drive motor 12 so that the rear drive motor shaft 14 extends into the module 10 and is engaged by the sprocket 16. The solenoid main shaft 22 is extended into an aligned sprocket recess 18 whenever the solenoid 20 is de-energized. Thus, shaft 22 locks the motor shaft 14 and thus locks the motor 12 when power is absent from the gate system to which the module 10 is connected. Therefore, in this mode, manual operation of the gate is prevented.

Solenoid 20 is energized to release the drive motor by withdrawing main shaft 22 from the sprocket recess 18, thereby freeing the motor shaft 14 to be manually rotated to physically open the gate barrier as required by UL-325. The solenoid's rear shaft 24 contacts limit switch 25 to indicate to the gate controller that the drive motor has been unlocked. Solenoid 20 is also energized whenever the gate controller is about to move the gate electrically so that the solenoid shaft will retract and allow normal operation of the gate control system. At the end of the full gate cycle (i.e., opening and closing), solenoid 20 is de-energized and the drive motor is once again locked.

Manual release of the gate under UL-325 is available by the action of key lock 30. With the use of an authorized key in key lock 30, arm actuator 32 is rotated from a locked position to an unlocked position. This action also rotates linkage arm 28 which pulls the solenoid shaft 24 down to contact limit switch 25 and unlock the motor shaft. The gate can then be driven manually to its open position. As a safety feature, when the drive motor 12 is mechanically released in this fashion, the output of limit switch 25 prevents the gate controller from initiating any movement of the gate, thus preventing injury to anyone mechanically pushing the gate to an open or closed condition.

It will now be understood that what has been disclosed herein is a motor locking module which may be added to an otherwise conventional gate controller system to provide motor locking and thus prevent unauthorized movement of a gate while still permitting simple electrical or mechanical release to comply with UL-325. It will be appreciated that such a locking module may take many different forms and be integrated in many different ways. Therefore, while one preferred embodiment has been disclosed in some detail to explain the structure and operation of the invention, various other embodiments will now become apparent. Accordingly, the scope hereof should be deemed to be limited only by the appended claims and their legal equivalents and not by the illustrated exemplary embodiment.

We claim:

1. A motor locking apparatus for use in automatic gate systems for permitting electrical operation of the gate and also permitting manual release of the gate system when it is desired to manually operate the gate, but preventing unauthorized manual operation of the gate system; the apparatus comprising:
a locking device selectively engaging the gate system drive motor whenever the gate system is de-energized, thereby preventing mechanically forced operation of the gate, said locking device being disengaged from the drive motor upon energization of the gate system for permitting operation of the gate system by either electrical or mechanical force.

2. The motor locking apparatus recited in claim 1 further comprising an electromechanical lock which locks said drive motor when de-energized and unlocks said drive motor when energized.

3. The motor locking apparatus recited in claim 2 wherein said electromechanical lock comprises a solenoid having a longitudinally moveable shaft; and
wherein said drive motor is affixed to a sprocket having at least one recess for receiving said solenoid shaft;
said solenoid being configured to engage said shaft with said at least one recess when said solenoid is de-energized and to withdraw said solenoid shaft from said recess when said solenoid is energized.

4. The motor locking apparatus recited in claim 3 further comprising a key-operated mechanical linkage, said linkage being engaged with said solenoid for mechanically withdrawing said solenoid shaft from said recess irrespective of whether said solenoid is energized or de-energized.

5. The motor locking apparatus recited in claim 3 further comprising a limit switch activated by said solenoid whenever said solenoid shaft is fully withdrawn from said recess.

6. The motor locking apparatus recited in claim 5 wherein said limit switch is connected to a controller of said gate system for preventing motorized operation of said gate when said solenoid shaft has been withdrawn from said recess without energization of said solenoid.

7. The motor locking apparatus recited in claim 4 wherein said limit switch is connected to a controller of said gate system for preventing motorized operation of said gate when said solenoid shaft has been withdrawn from said recess by operation of said key-operated mechanical linkage.

8. The motor locking apparatus recited in claim 1 further comprising an externally visible indicator for indicating whenever said locking device has been disengaged from the motor drive by energization of said gate system.
